(19) United States
(12) Patent Application Publication
(10) Pub. No.: US 2003/0195135 A1
(43) Pub. Date: Oct. 16, 2003

(54) Use of cationically modified, particulate, hydrophobic polymers as an additive for rinsing, cleaning and impregnating agents for hard surfaces

(76) Inventors: Dieter Boeckh, Limburgerhof (DE); Ralf Nörenberg, B?uuml;ttelborn (DE); S?ouml;ren Hildebrandt, Speyer (DE); Bernhard Mohr, Heidelberg (DE); Holger Schöpke, Neckargem?uuml;nd (DE); Reinhold J Leyrer, Dannstadt (DE); J?uuml;rgen Huff, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/296,231

(22) PCT Filed: Jun. 5, 2001
(86) PCT No.: PCT/EP01/06341

(30) Foreign Application Priority Data
Jun. 6, 2000 (DE) 10027638.5

(51) Int. Cl. C11D 3/37

(52) U.S. Cl. 510/475; 8/115.51

(57) ABSTRACT

Use of cationically modified, particulate, hydrophobic polymers, the surface of which has been cationically modified by coating with cationic polymers, and the particle size of which is 10 nm to 100 μm, as additive to rinse, cleaning and impregnation compositions for hard surfaces, and rinse, cleaning and impregnation compositions which comprise the cationically modified, particulate, hydrophobic polymers.

Use of cationically modified, particulate, hydrophobic polymers as additive to rinse, cleaning and impregnation compositions for hard surfaces

The invention relates to the use of cationically modified, particulate, hydrophobic polymers as additive to rinse, cleaning and impregnation compositions for hard surfaces, and to rinse, cleaning and impregnation compositions which comprise cationically modified, particulate, hydrophobic polymers.

Dispersions of particles of hydrophobic polymers, in particular aqueous dispersions of synthetic polymers and of waxes are used in the art to modify the properties of surfaces. For example, aqueous dispersions of finely divided hydrophobic polymers are used as binders in paper coating slips for the coating of paper or as coating compositions. The dispersions applied in each case to a substrate by customary methods, e.g. by knife-coating, painting, saturation or impregnation, are dried. During this, the dispersely distributed particles form a continuous film on the respective surface.

By contrast, aqueous washing, rinsing, cleaning and care processes are usually carried out in a heavily diluted liquor, where the ingredients of the formulation used in each case do not remain on the substrate, but instead are disposed of with the waste water. Modification of surfaces with dispersed hydrophobic particles takes place in the abovementioned processes only to an entirely unsatisfactory degree. Thus, for example, U.S. Pat. No. 3,580,853 discloses a detergent formulation which comprises a water-insoluble finely divided substance, such as biocides, and certain cationic polymers which increase the deposition and retention of the biocides on the surfaces of the ware.

Furthermore, U.S. Pat. No. 5,476,660 discloses the principle of using polymeric retention agents for cationic or zwitterionic dispersions of polystyrene or wax which have an active substance embedded within the dispersed particles. These dispersed particles are referred to as “carrier particles”, because they adhere to the surface treated, where they release the active ingredient, e.g. in the case of use in surfactant-containing formulations.

U.S. Pat. No. 3,993,830 discloses the application of a nonpermanent soil repellent finish to a textile ware by treating the textile ware with a dilute aqueous solution which comprises a polycarboxylate polymer and a water-soluble salt of a polyvalent metal. Suitable polycarboxylate polymers are, preferably, water-soluble copolymers of ethylenically unsaturated monocarboxylic acids and alkyl acrylates. The mixtures are used domestically for textile washing in the rinse cycle of the washing machine.

It is an object of the present invention to provide a further method for the modification of hard surfaces.

We have found that this object is achieved according to the invention by the use of cationically modified, particulate, hydrophobic polymers, the surface of which has been cationically modified by coating with cationic polymers, and the particle size of which is 10 nm to 100 μm, as additive to rinse, cleaning and impregnation compositions for hard surfaces.

The cationically modified, particulate, hydrophobic polymers are obtainable, for example, by treatment of aqueous dispersions of particulate, hydrophobic polymers having a particle size of from 10 nm to 100 μm with an aqueous solution or dispersion of a cationic polymer. This is carried out most simply by combining an aqueous dispersion of particulate, hydrophobic polymers having a particle size of from 10 nm to 100 μm with an aqueous solution or dispersion of a cationic polymer. The cationic polymers are preferably used in the form of aqueous solutions, although it is also possible to use aqueous dispersions of cationic polymers the dispersed particles of which have an average diameter up to 1 μm. In most cases, the two components are mixed at room temperature, although the mixing can also be carried out at temperatures of e.g. 0° to 100° C., provided that the dispersions do not coagulate upon heating.

The dispersions of the particulate, hydrophobic polymers can be stabilized using an anionic emulsifier or protective colloid. Other dispersions which can be used with equal success are free from protective colloids and emulsifiers, but contain, as hydrophobic polymers, copolymers which contain at least one anionic monomer in copolymerized form. Such dispersions of copolymers having anionic groups may optionally additionally comprise an emulsifier and/or a protective colloid. Anionic emulsifiers and/or protective colloids are preferably used for this purpose.

In the treatment of the anionically adjusted dispersions of the hydrophobic polymers with an aqueous solution of a cationic polymer, the charge of the originally anionically dispersed particles is changed such that, following the treatment, they preferably carry a cationic charge. Thus, for example, cationically modified dispersions of particulate, hydrophobic polymers in 0.1% strength by weight aqueous dispersion have an interface potential of from −5 to +50 mV, preferably from −2 to +25 mv, in particular from 0 to +15 mV. The interface potential is determined by measuring the electrophoretic mobility in dilute aqueous dispersion and the pH of the provided use liquor.

The pH of the aqueous dispersions of the cationically modified, particulate, hydrophobic polymers is, for example, 1 to 12, and is preferably in the range from 2 to 10, in particular in the range from 2.5 to 8. In the case of the use of particles of polymers with a content of more than 10% by weight of anionic monomers, the pH of the aqueous dispersions is 1 to 7.5, preferably 2 to 5.5, in particular 2.5 to 5.

The hydrophobic polymers to be used according to the invention are insoluble in water at the application pH. They are present therein in the form of particles with an average particle size of from 10 nm to 100 μm, preferably 25 nm to 20 μm, particularly preferably 40 nm to 2 μm and in particular 60 to 800 nm, and can be obtained from the aqueous dispersions as powders. The average particle size of the hydrophobic polymers can be determined, for example, under an electron microscope or using light scattering experiments.

In a preferred embodiment, the particles of the hydrophobic polymers to be used according to the invention exhibit pH-dependent solubility and swelling behavior. At a pH below 6.5, particularly below 5.5 and in particular below 5, the particles are water-insoluble and retain their particular character upon dispersion in concentrated and also in dilute aqueous media. By contrast, hydrophobic polymer particles containing carboxyl groups swell in water under neutral and alkaline conditions. This behavior of hydrophobic polymers having anionic groups is known from the literature, cf. M. Siddiq et al, who reported in Colloid. Polym. Sci. 277, 1172-1178 (1999) on the behavior of particles of methacrylic acid/ethyl acrylate copolymers in aqueous medium.

Hydrophobic polymers are obtainable, for example, by polymerization of monomers from the group of alkyl esters of C₃-C₅-monoethylenically unsaturated carboxylic acids and monohydric C₁-C₂₂-alcohols, hydroxyalkyl esters of C₃-C₅-monoethylenically unsaturated carboxylic acids and dihydric C₂-C₄-alcohols, vinyl esters of saturated C₁-C₁₈-carboxylic acids, ethylene, propylene, isobutylene, C₄-C₂₄-α-olefins, butadiene, styrene, α-methylstyrene, acrylonitrile, methacrylonitrile, tetrafluoroethylene, vinylidene fluoride, fluoroethylene, chlorotrifluoroethylene, hexafluoropropene, esters and amides of C₃-C₅-monoethylenically unsaturated carboxylic acids with amines -or alcohols containing perfluoroalkyl groups, allyl and vinyl esters of carboxylic acids containing perfluoroalkyl groups or mixtures thereof. These may be homopolymers or copolymers.

Examples of hydrophobic copolymers are copolymers of ethyl acrylate and vinyl acetate, copolymers of butyl acrylate and styrene, copolymers of (meth)acrylic esters of the perfluoroalkyl-substituted alcohols of the formula CF₃—(C₂F₄)ₙ—(CH₂)ₘ—OH or C₂F₅—(C₂F₄)ₙ—(CH₂)ₘ—OH (n=1-10, m=0-10) with (meth)acrylic esters and/or (meth)acrylic acid, copolymers of ethylene and tetrafluoroethylene, and copolymers of butyl acrylate and vinyl acetate. Said copolymers can contain the copolymerized monomers in any ratios.

The anionic character of the polymers mentioned can be achieved, for example, by copolymerizing the monomers which form the basis of the copolymers in the presence of small amounts of anionic monomers, such as acrylic acid, methacrylic acid, styrenesulfonic acid, acrylamido-2-methylpropanesulfonic acid, vinyl sulfonate and/or maleic acid and optionally in the presence of emulsifiers and/or protective colloids.

The anionic character of the polymers mentioned can, however, also be achieved by carrying out the copolymerization in the presence of anionic protective colloids and/or anionic emulsifiers.

The anionic character of the polymers mentioned can, however, also be achieved by emulsifying or dispersing the finished polymers in the presence of anionic protective colloids and/or anionic emulsifiers.

Hydrophobic polymers contain, for example,

(a) 40 to 100% by weight, preferably 50 to 90% by weight, particularly preferably 60 to 75% by weight, of at least one water-insoluble nonionic monomer,

(b) 0 to 60% by weight, preferably 1 to 55% by weight, particularly preferably 5 to 50% by weight, in particular 15 to 40% by weight, of at least one monomer containing carboxyl groups, or salts thereof,

(c) 0 to 25% by weight, preferably 0 to 15% by weight of a monomer containing sulfonic acid and/or phosphonic acid groups, or salts thereof,

(d) 0 to 55% by weight, preferably 0 to 40% by weight, of at least one water-soluble nonionic monomer and

(e) 0 to 10% by weight, preferably 0 to 5% by weight, of at least one polyethylenically unsaturated monomer

in copolymerized form.

Polymers which contain at least one anionic monomer (b) or (c) can be used without additional anionic emulsifiers or protective colloids. Polymers which contain less than 0.5% of anionic monomers are in most cases used together with at least one anionic emulsifier and/or protective colloid.

Preferred monomers (a) are methyl acrylate, ethyl acrylate, n-butyl acrylate, sec-butyl acrylate, tert-butyl acrylate, ethylhexyl acrylate, hydroxyethyl acrylate, hydroxypropyl acrylate, methyl methacrylate, n-butyl methacrylate, (meth)acrylic esters of the perfluoroalkyl-substituted alcohols CF₃—(C₂F₄)ₙ—(CH₂)ₘ—OH or C₂F₅—(C₂F₄)ₙ—(CH₂)_{m—OH (n=}2-8, m is 1 or 2), vinyl acetate, vinyl propionate, styrene, ethylene, propylene, butylene, isobutene, diisobutene and tetrafluoroethylene, and particularly preferred monomers a) are methyl acrylate, ethyl acrylate, n-butyl acrylate, tert-butyl acrylate and vinyl acetate.

Preferred hydrophobic polymers contain less than 75% by weight of a nonionic water-insoluble monomer (a) in copolymerized form whose homopolymers have a glass transition temperature T_{g} of more than 60° C.

Preferred monomers (b) are acrylic acid, methacrylic acid, maleic acid or maleic half-esters of C₁-C₈-alcohols.

Monomers of group (c) are, for example, acrylamido-2-methyl-propanesulfonic acid, vinylsulfonic acid, methallylsulfonic acid, vinylsulfonic acid, and the alkali metal and ammonium salts of these monomers.

Suitable monomers (d) are, for example, acrylamide, methacrylamide, N-vinylformamide, N-vinylacetamide, N-vinylpyrrolidone, N-vinyloxazolidone, methylpolyglycol acrylates, methylpolyglycol methacrylates and methylpolyglycol acrylamides. Preferred monomers (d) are vinylpyrrolidone, acrylamide and N-vinylformamide.

Suitable polyethylenically unsaturated monomers (e) are, for example, acrylic esters, methacrylic esters, allyl ethers or vinyl ethers of at least dihydric alcohols. The OH groups of the parent alcohols can be completely or partially etherified or esterified; however, the crosslinkers contain at least two ethylenically unsaturated groups. Examples are butanediol diacrylate, hexanediol diacrylate, trimethylolpropane triacrylate and tripropylene glycol diacrylate.

Further suitable polyethylenically unsaturated monomers (e) are, for example, allyl esters of unsaturated carboxylic acids, divinylbenzene, methylenebisacrylamide and divinylurea.

Such copolymers can be prepared by the known processes of solution, precipitation, suspension or emulsion polymerization of the monomers using free-radical polymerization initiators. The particulate, hydrophobic polymers are preferably obtained by the process of emulsion polymerization in water. The polymers have, for example, molar masses of from 1000 to 2 million, preferably from 5000 to 500,000, and in most cases the molar masses of the polymers are in the range from 10,000 to 150,000.

To limit the molar masses of the polymers, it is possible to add customary regulators during the polymerization. Examples of typical regulators are mercapto compounds, such as mercaptoethanol or thioglycolic acid.

Apart from said polymerization processes, other processes for the preparation of the polymer particles to be used according to the invention are also suitable. Thus, for example, polymers can be precipitated out by lowering the solubility of the polymers in the solvent. Such a method consists, for example, in dissolving a copolymer containing acid groups in a suitable water-miscible solvent, and metering in water in an excess such that the pH of the initial charge is at least one lower than the equivalent pH of the copolymer. Equivalent pH is understood as meaning the pH at which 50% of the acidic groups of the copolymer have been neutralized. In this process, it may be necessary to add a dispersion auxiliary, pH regulators and/or salts in order to obtain stable finely divided dispersions.

For the modification of finely divided hydrophobic polymers to be used according to the invention which contain anionic groups, it is possible, during the dispersion, to additionally add other polymers which partially or completely react or associate therewith and precipitate out. Such polymers are, for example, polysaccharides, polyvinyl alcohols and polyacrylamides.

Particulate, hydrophobic polymers can also be prepared by emulsifying a melt of the hydrophobic polymers in a controlled manner. For this, the polymer or a mixture of the polymer with further additives is, for example, melted and, under the action of strong shear forces, e.g. in an Ultra-Turrax, water is metered in in an excess such that the pH of the initial charge is at least one less than the equivalent pH of the polymer. Here, in some instances it may be necessary to add emulsifying auxiliaries, pH regulators and/or salts in order to obtain stable finely divided dispersions. For this variant of the preparation of finely divided polymer dispersions as well, it is possible to co-use additional polymers, such as polysaccharides, polyvinyl alcohols or polyacrylamides, particularly when the hydrophobic polymer contains anionic groups.

A further method for the preparation of finely divided hydrophobic polymers which contain anionic groups consists in treating aqueous, alkaline solutions of the polymers, preferably under the action of strong shear forces, with an acid.

Examples of anionic emulsifiers are anionic surfactants and soaps. Anionic surfactants which may be used are alkyl and alkenyl sulfates, sulfonates, phosphates and phosphonates, alkyl- and alkenylbenzenesulfonates, alkyl ether sulfates and phosphates, saturated and unsaturated C₁₀-C₂₅-carboxylic acids and salts thereof.

Nonionic and/or betainic emulsifiers can additionally be used. A description of suitable emulsifiers is given, for example, in Houben Weyl, Methoden der organischen Chemie [Methods of organic chemistry], Volume XIV/1, Makromolekulare Stoffe [Macromolecular substances], Georg Thieme Verlag, Stuttgart, 1961, pages 192 to 208.

Examples of anionic protective colloids are water-soluble anionic polymers. Here, it is possible to use very different types of polymer. Preference is given to using anionically substituted polysaccharides and/or water-soluble anionic copolymers of acrylic acid, methacrylic acid, maleic acid, maleic half-esters, vinylsulfonic acid, styrenesulfonic acid or acrylamidopropanesulfonic acid with other vinylic monomers. Suitable anionically substituted polysaccharides are, for example, carboxymethylcellulose, carboxymethyl starch, oxidized starch, oxidized cellulose and other oxidized polysaccharides, and the corresponding derivatives of the partially degraded polysaccharides.

Suitable water-soluble anionic copolymers are, for example, copolymers of acrylic acid with vinyl acetate, acrylic acid with ethylene, acrylic acid with acrylamide, acrylamidopropanesulfonic acid with acrylamide or acrylic acid with styrene.

Additionally, it is possible to use other nonionic and/or betainic protective colloids. An overview of customarily used protective colloids is given in Houben Weyl, Methoden der organischen Chemie [Methods in organic chemistry], Volume XIV/1, Makromolekulare Stoffe [Macromolecular substances], Georg Thieme Verlag, Stuttgart, 1961, pages 411 to 420.

For the preparation of particulate, hydrophobic polymers, preference is given to using anionic polymeric protective colloids which lead to primary particles having anionic groups on the particle surface.

The cationically modified, particulate, hydrophobic polymers to be used according to the invention are obtainable by coating the surface of the anionically dispersed, particulate, hydrophobic polymers with cationic polymers. Cationic polymers which may be used are all cationic synthetic polymers which contain amino and/or ammonium groups. Examples of such cationic polymers are polymers containing vinylamine units, polymers containing vinylimidazole units, polymers containing quaternary vinylimidazole units, condensates of imidazole and epichlorohydrin, crosslinked polyamidoamines, crosslinked polyamidoamines grafted with ethyleneimine, polyethyleneimines, alkoxylated polyethyleneimines, crosslinked polyethyleneimines, amidated polyethyleneimines, alkylated polyethyleneimines, polyamines, amine/epichlorohydrin polycondensates, alkoxylated polyamines, polyallylamines, polydimethyldiallylammonium chlorides, polymers containing basic (meth)acrylamide or (meth)acrylic ester units, polymers containing basic quaternary (meth)acrylamide or (meth)acrylic ester units, and/or lysine condensates.

Starting materials for the preparation of polymers containing vinylamine units are, for example, open-chain N-vinylcarboxamides of the formula

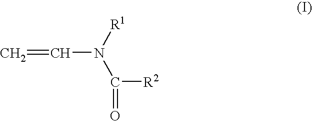

in which R¹ and R² may be identical or different and are hydrogen or C₁-C₆-alkyl. Suitable monomers are, for example, N-vinylformamide (R¹═R²═H in formula I), N-vinyl-N-methylformamide, N-vinylacetamide, N-vinyl-N-methylacetamide, N-vinyl-N-ethylacetamide, N-vinyl-N-methylpropionamide and N-vinylpropionamide. For the preparation of the polymers, said monomers can either be polymerized alone, in mixtures with one another or together with other monoethylenically unsaturated monomers. Preference is given to starting from homopolymers and copolymers of N-vinylformamide. Polymers containing vinylamine units are known, for example, from U.S. Pat. No.4,421,602, EP-A-0 216 387 and EP-A-0 251 182. They are obtained by hydrolysis of polymers which contain the monomers of the formula I in copolymerized form with acids, bases or enzymes.

Suitable monoethylenically unsaturated monomers which are copolymerized with the N-vinylcarboxamides are all compounds copolymerizable therewith. Examples thereof are vinyl esters of saturated carboxylic acids having 1 to 6 carbon atoms, such as vinyl formate, vinyl acetate, vinyl propionate and vinyl butyrate, and vinyl ethers, such as C₁-C₆-alkyl vinyl ethers, e.g. methyl or ethyl vinyl ether. Further suitable comonomers are ethylenically unsaturated C₃-C₆-carboxylic acids, for example acrylic acid, methacrylic acid, maleic acid, crotonic acid, itaconic acid and vinylacetic acid, and the alkali metal and alkaline earth metal salts thereof, esters, amides and nitriles of said carboxylic acids, for example methyl acrylate, methyl methacrylate, ethyl acrylate and ethyl methacrylate.

Cationic polymers are understood as also meaning amphoteric polymers which have a net cationic charge, i.e. the polymers contain both anionic and also cationic monomers in copolymerized form, but the molar proportion of the cationic units present in the polymer is greater than that of the anionic units.

Further suitable carboxylic esters are derived from glycols or polyalkylene glycols, only one OH group being esterified in each case, e.g. hydroxyethyl acrylate, hydroxyethyl methacrylate, hydroxypropyl acrylate, hydroxybutyl acrylate, hydroxypropyl methacrylate, hydroxybutyl methacrylate, and acrylic monoesters of polyalkylene glycols having a molar mass of from 500 to 10,000. Further suitable comonomers are esters of ethylenically unsaturated carboxylic acids with amino alcohols, such as, for example, dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, dimethylaminobutyl acrylate and diethylaminobutyl acrylate. The basic acrylates can be used in the form of the free bases, the salts with mineral acids, such as hydrochloric acid, sulfuric acid or nitric acid, the salts with organic acids, such as formic acid, acetic acid, propionic acid or the sulfonic acids or in quaternized form. Suitable quaternizing agents are, for example, dimethyl sulfate, diethyl sulfate, methyl chloride, ethyl chloride or benzyl chloride.

Further suitable comonomers are amides of ethylenically unsaturated carboxylic acids, such as acrylamide, methacrylamide, and N-alkylmono- and diamides of monoethylenically unsaturated carboxylic acids having alkyl radicals of from 1 to 6 carbon atoms, e.g. N-methylacrylamide, N,N-dimethylacrylamide, N-methylmethacrylamide, N-ethylacrylamide, N-propylacrylamide and tert-butylacrylamide, and basic (meth)acrylamides, such as dimethylaminoethylacrylamide, dimethylaminoethylmethacrylamide, diethylaminoethylacrylamide, diethylaminoethylmethacrylamide, dimethylaminopropylacrylamide, diethylaminopropylacrylamide, dimethylaminopropylmethacrylamide and diethylaminopropylmethacrylamide.

Further suitable comonomers are N-vinylpyrrolidone, N-vinylcaprolactam, acrylonitrile, methacrylonitrile, N-vinylimidazole, and substituted N-vinylimidazoles, such as N-vinyl-2-methylimidazole, N-vinyl-4-methylimidazole, N-vinyl-5-methylimidazole, N-vinyl-2-ethylimidazole and N-vinylimidazolines, such as N-vinylimidazoline, N-vinyl-2-methylimidazoline and N-vinyl-2-ethylimidazoline. N-vinylimidazoles and N-vinylimidazolines are used, apart from in the form of the free bases, also in a form neutralized with mineral acids or organic acids or in quaternized form, the quaternization preferably being carried out with dimethyl sulfate, diethyl sulfate, methyl chloride or benzyl chloride. Also suitable are diallyldialkylammonium halides, such as diallyldimethylammonium chlorides.

Also suitable as comonomers are monomers containing sulfo groups, such as, for example, vinylsulfonic acid, allylsulfonic acid, methallylsulfonic acid, styrenesulfonic acid, the alkali metal or ammonium salts of these acids or 3-sulfopropyl acrylate, the content of cationic units in the amphoteric copolymers exceeding the content of anionic units, meaning that the polymers overall have a cationic charge.

The copolymers comprise, for example,

99.99 to 1 mol %, preferably 99.9 to 5 mol %, of N-vinylcarboxamides of the formula I and

0.01 to 99 mol %, preferably 0.1 to 95 mol %, of other monoethylenically unsaturated monomers copolymerizable therewith

in copolymerized form.

In order to prepare polymers containing vinylamine units, preference is given to starting from homopolymers of N-vinylformamide or from copolymers obtainable by copolymerization of

N-vinylformamide with

vinyl formate, vinyl acetate, vinyl propionate, acrylonitrile, N-vinylcaprolactam, N-vinyl urea, acrylic acid, N-vinylpyrrolidone or C₁-C₆-alkyl vinyl ethers

and subsequent hydrolysis of the homopolymers and copolymers to form vinylamine units from the copolymerized N-vinylformamide units, the degree of hydrolysis being, for example, 0.1 to 100 mol %.

The hydrolysis of the above-described polymers takes place by known processes by the action of acids, bases or enzymes. Here, the copolymerized monomers of the above formula I give, as a result of cleaving off the group

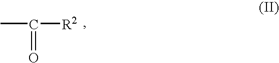

where R² has the meaning given therefor in formula I, polymers which contain vinylamine units of the formula

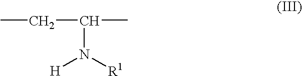

in which R¹ has the meaning given in formula I. If acids are used as hydrolysis agents, the units III are in the form of the ammonium salt.

The homopolymers of N-vinylcarboxamides of the formula I and their copolymers can be hydrolyzed to 0.1 to 100 mol %, preferably 70 to 100 mol %. In most cases, the degree of hydrolysis of the homopolymers and copolymers is 5 to 95 mol %. The degree of hydrolysis of the homopolymers is synonymous with the content of vinylamine units in the polymers. In the case of copolymers which contain vinyl esters in copolymerized form, in addition to the hydrolysis of the N-vinylformamide units, hydrolysis of the ester groups with the formation of vinyl alcohol units may arise. This is the case particularly if the hydrolysis of the copolymers is carried out in the presence of sodium hydroxide solution. Copolymerized acrylonitrile is likewise chemically changed during the hydrolysis. Here, amide groups or carboxyl groups, for example, arise. The homopolymers and copolymers containing vinylamine units may optionally contain up to 20 mol % of amidine units, which arise, for example, by the reaction of formic acid with two adjacent amino groups or by intramolecular reaction of one amino group with an adjacent amide group e.g. of copolymerized N-vinylformamide. The molar masses of the polymers containing vinylamine units are, for example, 1000 to 10 million, preferably 10,000 to 5 million (determined by light scattering). This molar mass range corresponds, for example, to K values of from 5 to 300, preferably 10 to 250 (determined in accordance with H. Fikentscher in 5% strength aqueous sodium chloride solution at 25° C. and a polymer concentration of 0.5% by weight).

The polymers containing vinylamine units are preferably used in salt-free form. Salt-free aqueous solutions of polymers containing vinylamine units can, for example, be prepared from the above-described salt-containing polymer solutions using ultrafiltration over suitable membranes at cut-offs of, for example, 1000 to 500,000 daltons, preferably 10,000 to 300,000 daltons. The aqueous solutions, described below, of other polymers containing amino and/or ammonium groups can also be obtained in salt-free form using ultrafiltration.

Polyethyleneimines are prepared, for example, by polymerization of ethyleneimine in aqueous solution in the presence of acid-eliminating compounds, acids or Lewis acids. Polyethyleneimines have, for example, molar masses up to 2 million, preferably from 200 to 500,000. Particular preference is given to using polyethyleneimines having molar masses of from 500 to 100,000. Also suitable are water-soluble crosslinked polyethyleneimines obtainable by reaction of polyethyleneimines with crosslinkers, such as epichlorohydrin or bischlorohydrin ethers of polyalkylene glycols having 2 to 100 ethylene oxide and/or propylene oxide units. Also suitable are amidic polyethyleneimines which are obtainable, for example, by amidation of polyethyleneimines with C₁-C₂₂-monocarboxylic acids. Further suitable cationic polymers are alkylated polyethyleneimines and alkoxylated polyethyleneimines. In the alkoxylation, 1 to 5 ethylene oxide or propylene oxide units are used, for example, per NH unit in polyethyleneimine.

Suitable polymers containing amino and/or ammonium groups are also polyamidoamines, which are obtainable, for example, by condensation of dicarboxylic acids with polyamines. Suitable polyamidoamines are obtained, for example, by reacting dicarboxylic acids having 4 to 10 carbon atoms with polyalkylenepolyamines which contain 3 to 10 basic nitrogen atoms in the molecule. Suitable dicarboxylic acids are, for example, succinic acid, maleic acid, adipic acid, glutaric acid, suberic acid, sebacic acid or terephthalic acid. In the preparation of polyamidoamines, it is also possible to use mixtures of dicarboxylic acids, and also mixtures of two or more polyalkylenepolyamines. Suitable polyalkylenepolyamines are, for example, diethylenetriamine, triethylenetetramine, tetraethylenepentamine, dipropylenetriamine, tripropylenetetramine, dihexamethylenetriamine, aminopropylethylenediamine and bisaminopropylethylenediamine. The dicarboxylic acids and polyalkylenepolyamines are, for the preparation of the polyamidoamines, heated to relatively high temperatures, e.g. to temperatures in the range from 120 to 220° C., preferably 130 to 180° C. The water which forms during the condensation is removed from the system. In the condensation, it may also be possible to use lactones or lactams of carboxylic acids having 4 to 8 carbon atoms. 0.8 to 1.4 mol of a polyalkylenepolyamine are, for example, used per mole of a dicarboxylic acid.

Further polymers containing amino groups are polyamidoamines grafted with ethyleneimine. They are obtainable from the above-described polyamidoamines by reaction with ethyleneimine in the presence of acids or Lewis acids, such as sulfuric acid or boron trifluoride etherates at temperatures of, for example, 80 to 100° C. Compounds of this type are described, for example, in DE-B-24 34 816.

The optionally crosslinked polyamidoamines which are optionally also additionally grafted prior to the crosslinking with ethyleneimine are also suitable as cationic polymers. The crosslinked polyamidoamines grafted with ethyleneimine are water-soluble and have, for example, an average molecular weight of from 3000 to 1 million daltons. Customary crosslinkers are, for example, epichlorohydrin or bischlorohydrin ethers of alkylene glycols and polyalkylene glycols.

Further examples of cationic polymers which contain amino and/or ammonium groups are polydiallyldimethylammonium chlorides. Polymers of this type are likewise known.

Further suitable cationic polymers or copolymers of, for example, 1 to 99 mol %, preferably 30 to 70 mol %, of acrylamide and/or methacrylamide and 99 to 1 mol %, preferably 70 to 30 mol %, of cationic monomers, such as dialkylaminoalkylacrylamide, dialkylaminoalkylacrylic ester and/or dialkylaminoalkylmethacrylamide and/or dialkylaminoalkylmethacrylic esters. The basic acrylamides and methacrylamides are likewise preferably in a form neutralized with acids or in quaternized form. Examples which may be mentioned are N-trimethylammoniumethylacrylamide chloride, N-trimethylammoniumethylmethacrylamide chloride, N-trimethylammoniumethylmethacrylic ester chloride, N-trimethylammoniumethylacrylic ester chloride, trimethylammoniumethylacrylamide methosulfate, trimethylammoniumethylmethacrylamide methosulfate, N-ethyldimethylammoniumethylacrylamide ethosulfate, N-ethyldimethylammoniumethylmethacrylamide ethosulfate, trimethylammoniumpropylacrylamide chloride, trimethylammoniumpropylmethacrylamide chloride, trimethylammoniumpropylacrylamide methosulfate, trimethylammoniumpropylmethacrylamide methosulfate and N-ethyldimethylammoniumpropylacrylamide ethosulfate. Preference is given to trimethylammonium propylmethacrylamide chloride.

Further suitable cationic monomers for the preparation of (meth)acrylamide polymers are diallyldimethylammonium halides, and basic (meth)acrylates. Copolymers of 1 to 99 mol %, preferably 30 to 70 mol %, of acrylamide and/or methacrylamide and 99 to 1 mol %, preferably 70 to 30 mol %, of dialkylaminoalkyl acrylates and/or methacrylates, such as copolymers of acrylamide and N,N-dimethylaminoethyl acrylate or copolymers of acrylamide and dimethylaminopropyl acrylate, for example, are suitable. Basic acrylates or methacrylates are preferably in a form neutralized with acids or in quaternized form. The quaternization can be carried out, for example, with methyl chloride or with dimethylsulfate.

Suitable cationic polymers which have amino and/or ammonium groups are also polyallylamines. Polymers of this type are obtained by homopolymerization of allylamine, preferably in a form neutralized with acids or in quaternized form, or by copolymerization of allylamine with other monoethylenically unsaturated monomers, which are described above as comonomers for N-vinylcarboxamides.

The cationic polymers have, for example, K values of from 8 to 300, preferably 100 to 180 (determined in accordance with H. Fikentscher in 5% strength aqueous sodium chloride solution at 25% and a polymer concentration of 0.5% by weight). At a pH of 4.5, they have, for example, a charge density of at least 1, preferably at least 4 meq/g of polyelectrolyte.

Examples of preferred cationic polymers are polydimethyldiallylammonium chloride, polyethyleneimine, polymers containing vinylamine units, copolymers of acrylamide or methacrylamide containing basic monomers in copolymerized form, polymers containing lysine units, or mixtures thereof. Examples of cationic polymers are:

copolymers of 50 mol % vinylpyrrolidone and 50 mol % trimethylammoniumethyl methacrylate methosulfate, M_{w} 1000 to 500,000,

copolymers of 30 mol % acrylamide and 70 mol % trimethylammonium ethylmethacrylate methosulfate, M_{w} 1000 to 1,000,000,

copolymers of 70 mol % acrylamide and 30 mol % dimethylaminoethylmethacrylamide, M_{w} 1000 to 1,000,000,

copolymers of 50 mol % hydroxyethyl methacrylate and 50 mol % 2-dimethylaminoethylmethacrylamide, M_{w} 1000 to 500,000.

It is also possible to incorporate by copolymerization anionic momonomers in minor amounts (<10% by weight), e.g. acrylic acid, methacrylic acid, vinylsulfonic acid or alkali metal salts of said acids.

Copolymers of 70 mol % hydroxyethyl methacrylate and 30 mol % 2-dimethylaminoethylmethacrylamide; copolymers of 30 mol % vinylimidazole methochloride, 50 mol % dimethylaminoethyl acrylate, 15 mol % acrylamide, 5 mol % acrylic acid,

polylysines with M_{w} of from 250 to 250,000, preferably 500 to 100,000 and lysine cocondensates having molar masses M_{w} of from 250 to 250,000, the cocondensable component used being, for example, amines, polyamines, ketene dimers, lactams, alcohols, alkoxylated amines, alkoxylated alcohols and/or nonproteinogenic amino acids,

vinylamine homopolymers, 1 to 99 mol % hydrolyzed polyvinylformamides, copolymers of vinylformamide and vinyl acetate, vinyl alcohol, vinylpyrrolidone or acrylamide having molar masses of from 3000 to 500,000,

vinylimidazole homopolymers, vinylimidazole copolymers with vinylpyrrolidone, vinylformamide, acrylamide or vinyl acetate having molar masses of from 5000 to 500,000, and quaternary derivatives thereof,

polyethyleneimines, crosslinked polyethyleneimines or amidated polyethyleneimines having molar masses of from 500 to 3,000,000,

amine/epichlorohydrin polycondensates which contain, as amine component, imidazole, piperazine, C₁-C₈-alkylamines, C₁-C₈-dialkylamines and/or dimethylaminopropylamine and which have a molar mass of from 500 to 250,000,

polymers containing basic (meth)acrylamide or (meth)acrylic ester units, polymers containing basic quaternary (meth)acrylamide or (meth)acrylic ester units and having molar masses of from 10,000 to 2,000,000.

In order to cationically modify anionically dispersed, particulate, hydrophobic polymers, they can, in addition to treatment with cationic polymers, also optionally be treated with polyvalent metal ions and/or cationic surfactants. A coating of the particles with polyvalent metal ions is achieved by, for example, adding an aqueous solution of at least one water-soluble, polyvalent metal salt to an aqueous dispersion of anionically dispersed hydrophobic polymers, or dissolving a water-soluble, polyvalent metal salt therein, the modification of the anionically dispersed hydrophobic particles with cationic polymers being carried out either before, at the same time as or after this treatment. Suitable metal salts are, for example, the water-soluble salts of Ca, Mg, Ba, Al, Zn, Fe, Cr or mixtures thereof. Other water-soluble heavy metal salts which are derived, for example, from Cu, Ni, Co and Mn can in principle be used, although they are not desired in all applications. Examples of water-soluble metal salts are calcium chloride, calcium acetate, magnesium chloride, aluminum sulfate, aluminum chloride, barium chloride, zinc chloride, zinc sulfate, zinc acetate, iron (II) sulfate, iron (III) chloride, chromium (III) sulfate, copper sulfate, nickel sulfate, cobalt sulfate and manganese sulfate. Preference is given to using the water-soluble salts of Ca, Al and Zn for the cationization.

The charge reversal of the anionically dispersed hydrophobic polymers is also possible with cationic polymers and cationic surfactants. Of potential suitability here are cationic surfactants having very different structures. An overview of a selection of suitable cationic surfactants is given in Ullmann's Encyclopedia of Industrial Chemistry, Sixth Edition, 1999, Electronic Release, Chapter “Surfactants”, Chapter 8, Cationic Surfactants.

Particularly suitable cationic surfactants are, for example,

C₇-C₂₅-alkylamines,

C₇-C₂₅—N,N-dimethyl-N-(hydroxyalkyl)ammonium salts,

mono- and di(C₇-C₂₅-)alkyldimethylammonium compounds quaternized with alkylating agents,

ester quats, such as, for example, quaternary esterified mono-, di- or trialkanolamines which have been esterified with C₈-C₂₂-carboxylic acids,

imidazoline quats, such as, for example, 1-alkylimidazolinium salts of the formulae IV or V

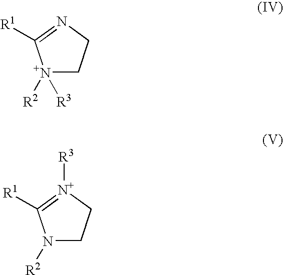

where

R¹═C₁-C₂₅-alkyl or C₂-C₂₅-alkenyl,

R²═C₁-C₄-alkyl or hydroxyalkyl and

R³═C₁-C₄-alkyl, hydroxyalkyl or a radical R¹—CO—X—(CH₂)ₙ— where X═O or NH and n=2 or 3, and

where at least one radical R¹═C₇-C₂₂-alkyl or C₇-C₂₂-alkenyl.

In the case of many commercial applications and everyday domestic applications, the modification of the properties of smooth or structured hard surfaces with dispersions is of importance. It is not always possible to carry out the modification of the surfaces by impregnation, spraying and painting processes with concentrated dispersions. It is frequently desirable to carry out the modification using a rinse of the material to be treated with a heavily diluted liquor comprising an active substance or by spraying on a heavily diluted aqueous formulation. Here, it is often desirable to combine the modification of the surface of materials in conjunction with a cleaning and/or care or impregnation of the surface. Surfaces of very different materials are suitable in practice. Hard surfaces are understood as meaning, for example, hard macroscopic surfaces, such as floor and wall coverings, exposed concrete, stone facades, plastered facades, glass surfaces, ceramic surfaces, metal surfaces, enamel surfaces, plastic surfaces, wood surfaces, surfaces of coated woods or painted surfaces, microscopic surfaces, such as porous bodies (e.g. foams, woods, leather, porous construction materials, porous minerals), floor and wall paints or coatings and cellulose fleece. Hard surfaces are preferably floor and wall objects made of glass and metal, and also painted metal surfaces.

The modification of the surfaces can consist, for example, in a hydrophobicization, soil release finishing of materials made of polyester, soil repellent finishing, a reinforcement of the nontextile fiber composite and the protection against chemical or mechanical influences or damage.

The cationically modified, particulate, hydrophobic polymers are used for the treatment of hard surfaces of the materials mentioned above by way of example as additive to rinse, impregnation and cleaning compositions. They can, for example, be used as the sole active component in aqueous rinse baths and, depending on the composition of the polymer, facilitate, for example, soil release in the case of a subsequent cleaning e.g. of cars in automatic washing installations, effect lower soil adhesion upon use, improve the structural retention of nontextile fibers, e.g. nonwovens, and effect a hydrophobicization of the surface of cleaned objects.

The treatment of hard surfaces is carried out using aqueous liquors which comprise, for example, 2.5 to 300 ppm, preferably 5 to 200 ppm and in particular 10 to 100 ppm of at least one cationic polymer and optionally additionally up to 10 mmol/l, preferably up to 5 mmol/l, particularly preferably up to 3.5 mol/l, of water-soluble salts of polyvalent metals, in particular salts of Ca, Mg or Zn and/or up to 2 mmol/l, preferably up to 0.75 mmol/l, of water-soluble Al salts and/or up to 600 ppm, preferably up to 300 ppm, of cationic surfactants. The concentration of the cationically modified, particulate, hydrophobic polymers in the case of use in a rinse, impregnation or cleaning bath is, for example, 0.0002 to 1.0% by weight, preferably 0.0005 to 0.25% by weight, particularly preferably 0.002 to 0.05% by weight.

In the case of the cleaning of hard surfaces domestically and in the commercial sector, the cationically coated polymeric particles according to the invention can be used in a variety of ways:

In the case of the use of particles which contain anionic groups in the polymer, the surface can be modified following cleaning with a rinse formulation such that soil is more readily removed in the subsequent cleaning step.

For example, the thorough cleaning with a neutral or alkaline cleaner is carried out, and the surface is then rinsed with an acidic afterrinse formulation which comprises the particles according to the invention. In the next cleaning, the soil is more readily released. The polymeric particles used for this purpose are swellable or soluble in neutral or alkaline water.

In another embodiment, the cationic particles are added directly to the cleaning formulation and modify the surface such that soil adheres less strongly to the surface. For example, it is possible to use cationically modified polymeric particles containing fluorine groups in such formulations. Preferably, such polymers contain more than 10% by weight, particularly preferably more than 25% by weight, of monomers containing fluorine groups.

In another embodiment, the surface is treated with an impregnation formulation, as a result of which the surface becomes water-repellent. For example, cationically modified polymeric particles, the polymers of which have only a content of monomers carrying anionic groups of below 10% by weight, preferably below 5% by weight, can be used in such formulations.

Compositions for the treatment of hard surfaces can be liquid, in gel form or solid.

The compositions can, for example, have the following composition:

(a) 0.05 to 40% by weight of cationically modified, particulate, hydrophobic polymers, the surface of which has been cationically modified by coating with cationic polymers, and the particle size of which is 10 nm to 100 μm,

(b) 0 to 20% by weight of at least one water-soluble salt of Ca, Mg, Al, Zn and/or 0.01 to 30% by weight of at least one cationic surfactant and/or 0.01 to 15% by weight of at least one cationic polymer,

(c) 0 to 80% by weight of at least one customary additive, such as acids or bases, inorganic builders, organic cobuilders, further surfactants, polymeric color transfer inhibitors, polymeric antiredeposition agents, soil release polymers, enzymes, complexing agents, corrosion inhibitors, waxes, silicone oils, light protection agents, dyes, solvents, hydrotropes, thickeners and/or alkanolamines and

(d) water to make up to 100% by weight.

In a preferred embodiment, the compositions comprise those hydrophobic polymers which contain, in copolymerized form, 25 to 60% by weight of an ethylenically unsaturated monomer containing at least one carboxylic acid group, and have a particle size of from 10 nm to 100 μm.

The compositions of this preferred embodiment are particularly suitable for achieving soil-release-promoting properties. Soilings are more readily removed from surfaces treated in this way during the next cleaning operation.

In a further preferred embodiment, the compositions comprise those hydrophobic polymers which contain, in copolymerized form, at least 75% by weight of a water-insoluble ethylenically unsaturated monomer, and have a particle size of from 10 nm to 100 μm.

The compositions of this preferred embodiment are particularly suitable for achieving hydrophobicizing or impregnating properties. Water is absorbed or let through to a significantly lesser extent by surfaces treated in this way.

In a further preferred embodiment, the compositions comprise those hydrophobic polymers which contain, in copolymerized form, 10 to 100% by weight of an ethylenically unsaturated monomer containing fluorine substituents, and have a particle size of from 10 nm to 100 μM.

The compositions of this preferred embodiment are particularly suitable for achieving soil-repellant properties. Oil or grease soiling is absorbed by surfaces treated in this way to a significantly lesser extent.

Preferred compositions in liquid or gel form for the care and cleaning of hard surfaces comprise, for example,

(a) 0.1 to 30% by weight of particulate, hydrophobic polymers which contain, in copolymerized form, at least one group of anionic ethylenically unsaturated monomers, have been cationically modified by treatment with cationic polymers, have a particle size of from 10 nm to 100 μm and have been dispersed in water,

(b) 0.05 to 20% by weight of an acid,

(c) 0 to 30% by weight of at least one water-soluble salt of Mg, Ca, Zn or Al and/or of a cationic surfactant and/or 0.01 to 15% by weight of at least one cationic polymer,

(d) 0 to 20% by weight of at least one other customary ingredient, such as perfume, further surfactants, silicone oil, light protection agents, dye, complexing agents, antiredeposition agent, soil release polyester, color transfer inhibitor, nonaqueous solvent, hydrotropic agent, thickener and/or alkanolamine and

(e) water to make up to 100% by weight.

Preference is given to those compositions which comprise

(a) 0.5 to 25% by weight of particulate, hydrophobic polymers which contain, in copolymerized form, 0.5 to 60% by weight of an ethylenically unsaturated monomer containing at least one carboxylic acid group, have a particle size of from 10 nm to 100 μm, and which have been dispersed in water using an anionic emulsifier and/or an anionic protective colloid,

(b) 0.05 to 10% by weight of at least one acid,

(c) 0.01 to 15% by weight of at least one cationic polymer,

(d) 0 to 30% by weight of at least one water-soluble salt of Mg, Ca, Zn or Al and/or of a cationic surfactant,

(e) 0 to 20% by weight of at least one other customary ingredient, such as perfume, further surfactants, silicone oil, light protection agents, dye, complexing agents, antiredeposition agent, soil release polyester, color transfer inhibitor, nonaqueous solvent, hydrotropic agent, thickener and/or alkanolamine and

(f) water to make up to 100% by weight.

A further example of a cleaning and care formulation in liquid or gel form is a composition comprising:

(a) 0.05 to 30% by weight of cationically modified, particulate, hydrophobic polymers, the surface of which has been cationically modified by coating with cationic polymers, and the particle size of which is 10 μm to 100 μm,

(b) 0.1 to 40% by weight of at least one nonionic or anionic surfactant,

(c) 0 to 30% by weight of at least one water-soluble salt of Mg, Ca, Zn or Al and/or of a cationic surfactant and/or 0.01 to 15% by weight of at least one cationic polymer,

(d) 0 to 10% by weight of at least one complexing agent,

(e) 0 to 20% by weight of other customary ingredients, such as pH regulators, extenders, thickeners, solvents, hydrotropic agents, polycarboxylic acids, silicones, brighteners, perfume and/or dyes and

(f) 0 to 90% by weight of water.

Another acidic cleaning formulation in liquid or gel form comprises, for example,

(a) 0.1 to 30% by weight of particulate, hydrophobic polymers which contain, in copolymerized form, at least one group of anionic ethylenically unsaturated monomers, have a particle size of from 10 nm to 100 μm and have been dispersed in water,

(b) 0.05 to 20% by weight of an acid,

(c) 0.1 to 30% by weight of at least one water-soluble cationic polymer,

(e) 0 to 10% by weight of at least one complexing agent,

(f) 0 to 20% by weight of other customary ingredients, such as pH regulators, extenders, surfactants, thickeners, solvents, hydrotropic agents, polycarboxylic acids, silicones, brighteners, perfume and/or dyes and

(g) 0 to 90% by weight of water.

Preferred acidic cleaning formulations in liquid or gel form and having a soil release-promoting action can have the following composition:

(a) 0.5 to 25% by weight of particulate, hydrophobic polymers which contain, in copolymerized form, 25 to 60% by weight of an ethylenically unsaturated monomer containing at least one carboxylic acid group, have a particle size of from 10 nm to 100 μm and have been dispersed in water using an anionic emulsifier and/or an anionic protective colloid,

(b) 0.1 to 40% by weight of at least one nonionic or anionic surfactant,

(c) 0.01 to 20% by weight of at least one water-soluble or water-dispersible cationic polymer,

(d) 0.1 to 30% by weight of at least one water-soluble salt of Mg, Ca, Zn or Al and/or of a cationic surfactant,

(e) 0.1 to 20% by weight of at least one acid,

(f) 0 to 10% by weight of at least one complexing agent,

(g) 0 to 20% by weight of other customary ingredients, such as pH regulators, extenders, thickeners, solvents, hydrotropic agents, polycarboxylic acids, silicones, brighteners, perfume and/or dyes and

(h) 0 to 90% by weight of water.

Solid cleaning formulations are also customary, e.g. mixtures of

(a) 0.05 to 30% by weight of cationically modified, particulate, hydrophobic polymers, the surface of which has been cationically modified by coating with cationic polymers, and the particle size of which is 10 nm to 100 μm,

(b) 0.1 to 40% by weight of at least one nonionic and/or anionic surfactant,

(c) 0 to 10% by weight of a cationic polymer,

(d) 0 to 20% by weight of a water-soluble salt of Mg, Ca, Zn or Al and/or of a cationic surfactant,

(e) 0 to 80% by weight of an inorganic builder, extender and/or scouring agent,

(f) 0 to 20% by weight of a complexing agent and/or organic cobuilder,

(g) 0 to 10% by weight of other customary ingredients, such as brighteners, waxes, oils, perfume, corrosion inhibitors, bleaches, bleach activators, bleach catalysts, dyes and

(h) water to 100%.

A further example of an afterrinse and impregnation formulation in liquid or gel form is a mixture of

(a) 0.05 to 30% by weight of cationically modified, particulate, hydrophobic polymers, the surface of which has been cationically modified by coating with cationic polymers, and the particle size of which is 10 nm to 100 μm,

(b) 0.1 to 30% by weight of at least one nonionic or anionic surfactant,

(c) 0 to 10% by weight of at least one acid, preferably a carboxylic acid,

(d) 0 to 10% by weight of a cationic polymer,

(e) 0 to 20% by weight of a water-soluble salt of Mg, Ca, Zn or Al and/or of a cationic surfactant,

(f) 0 to 10% by weight of other customary ingredients, such as thickeners, complexing agents, solvents, oils, waxes, hydrotropic agents, foam-suppressing agents, polycarboxylic acids, silicones, brighteners, perfume, dyes and

(g) 0 to 90% by weight of water.

Suitable acids are both mineral acids, such as sulfuric acid or phosphoric acid, and organic acids, such as carboxylic acids or sulfonic acids. Strong acids, such as sulfuric acid, phosphoric acid or sulfonic acids are usually used here in partially neutralized form.

The rinse, care and cleaning formulations in liquid or gel form described above can be formulated on the basis of the same ingredients also as solid compositions. Examples of solid forms are powders, granules and tablets.

To prepare solid compositions, it may be necessary to additionally add extenders, spraying auxiliaries, agglomeration auxiliaries, coating auxiliaries or binders. To ensure the effect and also good dissolution behavior, it may additionally be necessary to add dissolution-promoting components, such as readily water-soluble salts, polymeric disintegrants or combinations of acids and hydrogencarbonate.

The cationic modification of the particulate, hydrophobic polymers is preferably carried out prior to use in the aqueous treatment compositions, although it can also be carried out during the preparation of the aqueous treatment compositions or the use of anionically emulsified, particulate, hydrophobic polymers having a particle size of from 10 nm to 100 μm by, for example, mixing aqueous dispersions of the suitable particulate polymers with the other constituents of the respective treatment composition in the presence of cationic polymers and optionally additionally of water-soluble salts of polyvalent metals and/or cationic surfactants.

In a particular embodiment, the anionic particles or formulations containing these particles can also be added directly to the rinse or cleaning liquor if it is ensured that sufficient amounts of cationic polymers and optionally of polyvalent metal ions and/or cationic surfactants are present in the liquor in dissolved form.

The anionic particles or formulations comprising these particles can also be metered in before, after or at the same time as the formulation containing cationic polymers or optionally cationic surfactants.

Examples of the composition of typical anionic dispersions which can be processed by mixing with cationic polymers and optionally additionally water-soluble salts of polyvalent metals and/or cationic surfactants, and also optionally other components to give rinse, care, impregnation and cleaning compositions for the treatment of hard surfaces are the dispersions I to III described below, the dispersed particles of which are in each case to be observed, upon electron microscopic investigation, as discrete particles having the given average particle diameter:

Dispersion I

40% strength by weight aqueous dispersion of a polymer of 56% by weight of ethyl acrylate, 33% by weight of methacrylic acid and 11% by weight of acrylic acid having an average particle diameter of 288 nm. The dispersion comprised 1.25% by weight of an anionic surfactant as emulsifier and 20% by weight of a low molecular weight starch as protective colloid. It had a pH of 4.

Dispersion II

30% strength by weight aqueous dispersion of a polymer of 66% by weight of ethyl acrylate, 4% by weight of methacrylic acid, 26% by weight of acrylic acid and 4% by weight of acrylamide. The average diameter of the dispersed particles of the dispersion was 176 nm. The dispersion comprised 0.8% by weight of an anionic surfactant as emulsifier and had a pH of 4.

Dispersion III

30% strength by weight aqueous dispersion of a polymer of 50% by weight of ethyl acrylate and 50% by weight of methacrylic acid having an average diameter of the dispersed particles of 123 nm. The dispersion comprised 0.8% by weight of an anionic surfactant as emulsifier and had a pH of 4.

From the dispersions I to III it is possible to prepare typical formulations according to the invention having soil release-promoting action and which are used, for example, for the cleaning of dishes in the rinse cycle, for the aftertreatment of floors or floor coverings after cleaning or for the afterrinsing of automobiles after washing in a dose of from 0.1 to 10 g/l, preferably from 2 to 5 g/l, particularly preferably 3 g/l:

Dispersion IV

35% strength by weight dispersion of a polymer of 64% by weight of n-butyl acrylate, 32% by weight of methyl methacrylate and 4% by weight of acrylic acid. The average diameter of the dispersed particles of the dispersion was 80 nm. The dispersion comprises 1.5% by weight of an anionic surfactant as emulsifier and had a pH of 6.

Dispersion V

Anionic fluoropolymer dispersion Nuva®FTA-4 (Clariant).

Formulation I

50% by weight of one of the dispersions I to III described above

1.5% by weight of formic acid

1.5% by weight of imidazole/epichlorohydrin polymer of molar mass M_{w} 12,000 and

water to make up to 100% by weight.

Formulation II

50% by weight of one of the dispersions I to III described above

1.5% by weight of formic acid

1.5% by weight of imidazole/epichlorohydrin polymer of molar mass M_{w} 12,000

10% by weight of an ester quat (methyl quat of the ditallow fatty acid ester of triethanolamine) and

water to make up to 100% by weight.

Formulation III

50% by weight of one of the dispersions I to III described above

2% by weight of 2N sulfuric acid

1.5% by weight of water-soluble crosslinked polyethyleneimine of molar mass M_{w} 1,000,000 and

water to make up to 100% by weight.

Formulation IV

50% by weight of one of the dispersions I to III described above

2% by weight of 2N sulfuric acid

1.5% by weight of water-soluble crosslinked polyethyleneimine of

molar mass M_{w} 1,000,000

5% by weight of an ester quat (methyl quat of the ditallow fatty acid ester of triethanolamine) and

water to make up to 100% by weight.

Dispersions IV and V can be used to prepare typical formulations according to the invention with impregnating action, which can be used, for example, for the water-repellant or oil-repellant impregnation of wood, leather, plaster, paints, cellulose nonwovens and surface coatings in a dose of 1-10 g/l. Application can take place by rinsing the surface or by spraying on the diluted liquor.

Formulation V

15% by weight of the dispersion IV described above

0.25% by weight of polyethyleneimine of molar mass M_{w} 5,000

5% by weight of polyvinylpyrrolidone

water to make up to 100% by weight,

where all components have been adjusted to pH 6 with formic acid.

Formulation VI

30% by weight of the dispersions V described above

0.1% by weight of polyethyleneimine of molar mass M_{w} 25,000

2.5% by weight of calcium acetate

5% by weight of formic acid

water to make up to 100% by weight.

The formulations I to IV can optionally comprise further constituents, such as customary soil release polymers for polyesters, antiredeposition agents, perfume, dyes, enzymes, hydrotropic agents, solvents, nonionic surfactants, silicone oil, a textile softener and/or a thickener.

Suitable hydrophobicizing and soil-repelling additives to rinse and cleaning compositions are, for example, the following aqueous dispersions, the dispersed particles of which have an average diameter of from 10 nm to 100 μm:

copolymers of butyl acrylate and styrene containing anionic dispersant

copolymers of butyl acrylate and vinyl acetate containing anionic dispersant

tetrafluoroethylene polymers containing anionic dispersant.

The anionic character of the abovementioned dispersions can, if appropriate, additionally be established by polymerizing the polymers in the presence of small amounts (up to 10% by weight) of anionic monomers, such as acrylic acid, styrenesulfonic acid, vinylphosphonic acid or acrylamido-2-methylpropanesulfonic acid. These dispersions are preferably firstly cationically modified by treatment with cationic polymers and optionally water-soluble salts of polyvalent metals or with cationic surfactants, or the cationic modification of the dispersions is carried out during the preparation of the rinse or care compositions, as is described above under formulations I to VI.

The surfactants, builders, cobuilders, complexing agents, solvents, color transfer inhibitors, soil release polyesters, bleaches, bleach activators, antiredeposition agents, enzymes, perfumes, solvents, thickeners, oils, waxes, hydrotropic agents, foam-suppressing agents, silicones, brighteners and dyes mentioned in the various formulations can be combined within the scope of the ingredients customary in rinse, care, detergent and cleaning formulations. For typical ingredients, reference may be made to the chapter Detergents (part 3, Detergent Ingredients, part 4, Household Detergents and part 5, Institutional Detergents) in Ullmann's Encyclopedia of Industrial Chemistry, Sixth Edition, 2000 Electronic Version 2.0.

Preferred nonionic surfactants are, for example, alkoxylated C₈-C₂₂-alcohols, such as fatty alcohol ethoxylates or oxo alcohol alkoxylates which have been alkoxylated with 3 to 15 mol of ethylene oxide and optionally additionally with 1 to 4 mol of propylene oxide or butylene oxide, and also block polymers of ethylene oxide and propylene oxide with a molar mass of from 900 to 12,000 and a weight ratio of ethylene oxide to propylene oxide of from 1 to 20.

Particularly preferred nonionic surfactants are C₁₃/C₁₅-oxo alcohol ethoxylates and C₁₂/C₁₄-fatty alcohol ethoxylates which have been alkoxylated with 3 to 11 mol of ethylene oxide per mole of alcohol or firstly with 3 to 10 mol of ethylene oxide and then with 1 to 3 mol of propylene oxide per mole of alcohol.

Preferred anionic surfactants are, for example, alkylbenzenesulfonates with linear or branched C₆-C₂₅-alkyl groups, fatty alcohol or oxo alcohol ether sulfates with C₈-C₂₂-alkyl groups and fatty alcohol or oxo alcohol ether sulfates of C₈-C₂₂-alcohols which have been ethoxylated with 1 to 5 mol of ethylene oxide per mole of alcohol, and which have been sulfated on the OH end-group of the ethoxylate.

Formulations according to the invention are preferably formulated with a low content of anionic surfactants, and are particularly preferably free from anionic surfactants. If anionic surfactants are used in the the formulations, preference is given to using ether sulfates.

Preferred solvents are alcohols, such as methanol, ethanol, isopropanol, n-butanol, isobutanol, ethylene glycol, propylene glycol, diethylene glycol, triethylene glycol, dipropylene glycol, tripropylene glycol and butanediol.

Preferably, only small amounts, particularly preferably no, solvent are added to the formulations.

Preferred builders are alkali metal carbonates, phosphates, polyphosphates, zeolites and silicates. Particularly preferred builders are zeolite A, zeolite P, phyllosilicates, soda and trisodium polyphosphate.

Preferred complexing agents are nitriloacetic acid, methylglycinediacetic acid and ethylenediamine tetraacetate.

Preferred cobuilders are acrylic acid homopolymers, acrylic acid/maleic acid copolymers, polyaspartic acid and citric acid. Particularly preferred cobuilders are acrylic acid homopolymers of molar mass 1,500 to 30,000 and acrylic acid/maleic acid copolymers with a molar ratio of the monomers of from 10:1 to 1:2 and molar masses of from 4,000 to 100,000.

Preferred soil release polyesters are polyesters of terephthalic acid, ethylene glycol and polyethylene glycol, where polyethylene glycols with molar masses of from 1,000 to 5,000 are incorporated by condensation, and also those polyesters in which terephthalic acid is replaced in an amount up to 50 mol % by sulfocarboxylic acids and/or sulfodicarboxylic acids.

Preferred color transfer inhibitors are polyvinylpyrrolidone of molar masses 8,000 to 70,000, vinylimidazole/vinylpyrrolidone copolymers with a molar ratio of the monomers of from 1:10 to 2:1 and molar masses of from 8,000 to 70,000, and also poly-4-vinylpyridine N-oxides with molar masses of from 8,000 to 70,000.

Preferred enzymes are proteases, lipases, cellulases and amylases.

Formulations according to the invention can, where necessary, additionally comprise further protective colloids for stabilizing the disperse state. This is of particular importance particularly for liquid formulations in order to prevent coagulation. The protective colloids can, however, also be added advantageously to solid formulations in order to prevent coagulation upon use.

Protective colloids which may be used are water-soluble polymers, in particular water-soluble nonionic polymers. Suitable protective colloids preferably have molar masses of from 800 to 200,000, particularly preferably from 5,000 to 75,000, in particular from 10,000 to 50,000.

Suitable protective colloids are, for example, polyvinylpyrrolidone, polyethylene glycol, block polymers of ethylene oxide and propylene oxide, enzymatically degraded starches and polyacrylamides.

The hard surfaces treated with the dispersions of cationically modified hydrophobic polymers to be used in accordance with the invention, such as surfaces of glass, plastics, metals, wood and ceramic, exhibit changed properties. Depending on the way in which the process is carried out, the surfaces treated in this way can, following a soiling, be more readily freed from the soilings in a subsequent aqueous cleaning process than the untreated surfaces, and/or exhibit greater repellency of oil or water.

The percentages in the Examples are percentages by weight.

### EXAMPLES

Dispersion I

40% strength by weight aqueous dispersion of a polymer of 56% by weight of ethyl acrylate, 33% by weight of methacrylic acid and 11% by weight of acrylic acid having an average particle diameter of 288 nm. The dispersion comprised 1.25% by weight of an anionic surfactant as emulsifier and 20% by weight of a low molecular weight starch as protective colloid. The anionic dispersion had a pH of 4.

To test the soil release properties of hard surfaces, experiments were carried out on glass plates:

### Comparative Example 1

The dispersion I was brought to a content of 0.040% by weight using deionized water of pH 4, a clean glass plate was placed into the dispersion for 5 min, then removed and dried in the air.

A lipstick was used to apply a mark to the plate. In order to clean it, the plate was then placed for 5 minutes into a magnetically stirred solution at 40° C. of 5 g/l of sodium carbonate and 200 mg/l of C_{12/14}-fatty alcohol sulfate in water with 1 mmol of Ca hardness. The plate was then removed and it was tested how easily the soiling could be removed using a damp cloth.

### Example 1

The dispersion I was brought to a content of particles of 10% by weight with deionized water of pH 4. This dispersion was metered in, with stirring with a magnetic stirrer, to an equal volume of a 1% strength by weight aqueous solution, adjusted to pH 4, of high molecular weight polyethyleneimine (molar mass M_{w} 2,000,000) in 30 min. This produced a cationically modified dispersion which was stable for hours.

The cationically modified dispersion was diluted with deionized water of pH 4 to a solids content of 0.040% by weight. A clean glass plate was then placed into this dispersion for 5 min. The glass plate was then removed and dried in the air. A mark was then applied to the plate treated in this way using a lipstick.

In order to clean the plate, it was placed for 5 minutes into a magnetically stirred solution at 40° C. of 5 g/l of sodium carbonate and 200 mg/l of C_{12/14}-fatty alcohol sulfate in water with 1 mmol of Ca hardness. The plate was then removed and it was tested how easily the soiling could be removed using a damp cloth.

A comparison of the cleaning action of Example 1 with the Comparative Example 1 showed a clearly better soil release from the glass plate which had been treated prior to the soiling with the cationically modified dispersion I than from the glass plate pretreated with the dispersion I.

To test the hydrophobicizing properties on hard surfaces, experiments with glass surfaces were carried out.

Thus, clean glass plates were immersed in a rinse liquor for 10 sec and then dried in the air. After 24 h, the contact angle of a water drop was measured (Example 2). For comparison, the contact angle of a clean glass plate treated only with water (Comparative Example 2) and of a glass plate which had been treated with a liquor containing non-cationically modified polymeric particles (Comparative Example 3) was compared. A high value for the contact angle means here considerable hydrophobicization of the surface.

### Example 2

100 g of a dispersion of 570 mg of the dispersion IV and 8 mg of polyethyleneimine of molar mass M_{w} 25,000 in deionized water were prepared by dissolving the polyethyleneimine in 50 ml of water and adjusting the solution to pH 6 with acetic acid, then metering into this solution the dispersion IV diluted with 30 ml of deionized water in 30 min, the pH was adjusted to 6 using acetic acid and the measurement was made up to 100 ml with deionized water.

The resulting dispersion of cationically modified particles was diluted in the ratio 1:10 with water which contained 1 mmol/l of CaCl₂. This liquor was used for rinsing the glass plate. For this purpose, clean glass plates were immersed in the rinse liquor for 10 sec and dried in the air. After 24 h, the contact angle of a water drop placed onto the surface was measured. The contact angle was 61.5°.

### Comparative Example 2

For this, a clean glass plate was immersed in water of pH 6, which comprised 1 mmol/l of CaCl₂, for 10 sec and dried in the air. After 24 h, the contact angle of a water drop placed onto the surface was measured. The contact angle was 23.9°.

### Comparative Example 3

570 mg of the anionic dispersion IV were diluted with 50 ml of deionized water, adjusted to pH 6 with acetic acid and made up to 100 ml with deionized water. The resulting dispersion of anionic particles was diluted in the ratio 1:10 with water which comprised 1 mmol/l of CaCl₂.

This liquor was used for rinsing the glass plate. For this purpose, clean glass plates were immersed in the rinse liquor for 10 sec and dried in the air. After 24 h, the contact angle of a water drop placed onto the surface was measured. The contact angle was 31.5°.

The comparison of Example 2 with the Comparative Example 2 shows that by rinsing the glass surface with the cationically modified dispersion, considerable hydrophobicization is achieved compared with the untreated glass surface. The comparison with the Comparative Example 3 in which the rinsing was carried out without prior cationic modification of the particles shows that without the cationic modification, only a very much lower hydrophobicization arises.

We claim:

1. The use of cationically modified, particulate, hydrophobic polymers, the surface of which has been cationically modified by coating with cationic polymers, and the particle size of which is 10 nm to 100 μm, as additive to rinse, cleaning and impregnation compositions for hard surfaces.

2. The use as claimed in claim 1, wherein the cationically modified, particulate, hydrophobic polymers are obtainable by treatment of aqueous dispersions of particulate, hydrophobic polymers having a particle size of from 10 nm to 100 μm with an aqueous solution of cationic polymers.

3. The use as claimed in claim 1 or 2, wherein the dispersions of the particulate, hydrophobic polymers have been stabilized using an anionic emulsifier and/or anionic protective colloid.

4. The use as claimed in any of claims 1 to 3, wherein the hydrophobic polymers contain at least one anionic monomer in copolymerized form.

5. The use as claimed in any of claims 1 to 4, wherein the cationically modified dispersions of particulate, hydrophobic polymers in 0.1% strength by weight aqueous dispersion have an interface potential of from −5 to +50 mV.

6. The use as claimed in any of claims 1 to 5, wherein the pH of the aqueous dispersions of the cationically modified, particulate, hydrophobic polymers is 2 to 12.

7. The use as claimed in any of claims 1 to 6, wherein the concentration of the cationically modified, particulate, hydrophobic polymers in the case of use in a rinse or impregnation bath or in the cleaning composition liquor is 0.0002 to 1.0% by weight.

8. The use as claimed in any of claims 1 to 7, wherein the concentration of the cationically modified, particulate, hydrophobic polymers in the case of use in a rinse or impregnation bath or in the cleaning composition liquor is 0.002 to 0.05% by weight.

9. The use as claimed in any of claims 1 to 8, wherein the cationic polymers used are polymers containing vinylamine units, polymers containing vinylimidazole units, polymers containing quaternary vinylimidazole units, condensates of imidazole and epichlorohydrin, crosslinked polyamidoamines, crosslinked polyamidoamines grafted with ethyleneimine, polyethyleneimines, alkoxylated polyethyleneimines, crosslinked polyethyleneimines, amidated polyethyleneimines, alkylated polyethyleneimines, polyamines, amine/epichlorohydrin polycondensates, alkoxylated polyamines, polyallylamines, polydimethyldiallylammonium chlorides, polymers containing basic (meth)acrylamide or (meth)acrylic ester units, polymers containing basic quaternary (meth)acrylamide or (meth)acrylic ester units, and/or lysine condensates.

10. The use as claimed in any of claims 1 to 9, wherein the cationically modified, particulate, hydrophobic polymers have additionally been cationically modified by coating with polyvalent metal ions and/or cationic surfactants.

11. A composition for the treatment of hard surfaces, which comprises
(a) 0.05 to 40% by weight of cationically modified, particulate, hydrophobic polymers, the surface of which has been cationically modified by coating with cationic polymers, and the particle size of which is 10 nm to 100 μm,
(b) 0 to 20% by weight of at least one water-soluble salt of Ca, Mg, Al, Zn and/or 0.01 to 30% by weight of at least one cationic surfactant and/or 0.01 to 15% by weight of at least one cationic polymer,
(c) 0 to 80% by weight of at least one customary additive, such as acids or bases, inorganic builders, organic cobuilders, further surfactants, polymeric color transfer inhibitors, polymeric antiredeposition agents, soil release polymers, enzymes, complexing agents, corrosion inhibitors, waxes, silicone oils, light protection agents, dyes, solvents, hydrotropes, thickeners and/or alkanolamines and
(d) water to make up to 100% by weight.

12. A composition as claimed in claim 11, wherein the hydrophobic polymers contain, in copolymerized form, 25 to 60% by weight of an ethylenically unsaturated monomer containing at least one carboxylic acid group.

13. A composition as claimed in claim 11, wherein the hydrophobic polymers contain, in copolymerized form, at least 75% by weight of a water-insoluble ethylenically unsaturated monomer.

14. A composition as claimed in claim 11, wherein the hydrophobic polymers contain, in copolymerized form, 10 to 100% by weight of an ethylenically unsaturated monomer which contains fluorine substituents.

15. A composition in liquid or gel form for the care and cleaning of hard surfaces, which comprises
(a) 0.1 to 30% by weight of particulate, hydrophobic polymers which contain, in copolymerized form, at least one group of anionic ethylenically unsaturated monomers, have been cationically modified by treatment with cationic polymers, have a particle size of from 10 nm to 100 μm and have been dispersed in water,
(b) 0.05 to 20% by weight of an acid,
(c) 0 to 30% by weight of at least one water-soluble salt of Mg, Ca, Zn or Al and/or of a cationic surfactant and/or 0.01 to 15% by weight of at least one cationic polymer,
(d) 0 to 20% by weight of at least one other customary ingredient, such as perfume, further surfactants, silicone oil, light protection agents, dye, complexing agents, antiredeposition agent, soil release polyester, color transfer inhibitor, nonaqueous solvent, hydrotropic agent, thickener and/or alkanolamine and
(e) water to make up to 100% by weight.

16. A composition as claimed in claim 15, which comprises
(a) 0.5 to 25% by weight of particulate, hydrophobic polymers which contain, in copolymerized form, 5 to 45% by weight of an ethylenically unsaturated monomer containing at least one carboxylic acid group, have a particle size of from 10 nm to 100 μm, and which have been dispersed in water using an anionic emulsifier and/or an anionic protective colloid,
(b) 0.05 to 10% by weight of at least one acid,
(c) 0.01 to 15% by weight of at least one cationic polymer,
(d) 0 to 30% by weight of at least one water-soluble salt of Mg, Ca, Zn or Al and/or of a cationic surfactant,
(e) 0 to 20% by weight of at least one other customary ingredient, such as perfume, further surfactants, silicone oil, light protection agents, dye, complexing agents, antiredeposition agent, soil release polyester, color transfer inhibitor, nonaqueous solvent, hydrotropic agent, thickener and/or alkanolamine and
(f) water to make up to 100% by weight.

17. A cleaning and care formulation in liquid or gel form, which comprises
(a) 0.05 to 30% by weight of cationically modified, particulate, hydrophobic polymers, the surface of which has been cationically modified by coating with cationic polymers, and the particle size of which is 10 nm to 100 μm,
(b) 0.1 to 40% by weight of at least one nonionic or anionic surfactant,
(c) 0 to 30% by weight of at least one water-soluble salt of Mg, Ca, Zn or Al and/or of a cationic surfactant and/or 0.01 to 15% by weight of at least one cationic polymer,
(d) 0 to 10% by weight of at least one complexing agent,
(e) 0 to 20% by weight of other customary ingredients, such as pH regulators, extenders, thickeners, solvents, hydrotropic agents, polycarboxylic acids, silicones, brighteners, perfume and/or dyes and
(f) 0 to 90% by weight of water.

18. An acidic cleaning formulation in liquid or gel form, which comprises
(a) 0.1 to 30% by weight of particulate, hydrophobic polymers which contain, in copolymerized form, at least one group of anionic ethylenically unsaturated monomers, have a particle size of from 10 nm to 100 μm and have been dispersed in water,
(b) 0.05 to 20% by weight of an acid,
(c) 0.1 to 30% by weight of at least one water-soluble cationic polymer,
(e) 0 to 10% by weight of at least one complexing agent,
(f) 0 to 20% by weight of other customary ingredients, such as pH regulators, extenders, surfactants, thickeners, solvents, hydrotropic agents, polycarboxylic acids, silicones, brighteners, perfume and/or dyes and
(g) 0 to 90% by weight of water.

19. An acidic cleaning formulation in liquid or gel form which comprises
(a) 0.5 to 25% by weight of particulate, hydrophobic polymers which contain, in copolymerized form, 25 to 60% by weight of an ethylenically unsaturated monomer containing at least one carboxylic acid group, have a particle size of from 10 nm to 100 μm and have been dispersed in water using an anionic emulsifier and/or an anionic protective colloid,
(b) 0.01 to 40% by weight of at least one nonionic or anionic surfactant,
(c) 0.01 to 20% by weight of at least one water-soluble or water-dispersible cationic polymer,
(d) 0.1 to 30% by weight of at least one water-soluble salt of Mg, Ca, Zn or Al and/or of a cationic surfactant,
(e) 0.1 to 20% by weight of at least one acid,
(f) 0 to 10% by weight of at least one complexing agent,
(g) 0 to 20% by weight of other customary ingredients, such as pH regulators, extenders, thickeners, solvents, hydrotropic agents, polycarboxylic acids, silicones, brighteners, perfume and/or dyes and
(h) 0 to 90% by weight of water.

20. A solid cleaning formulation which comprises
(a) 0.05 to 30% by weight of cationically modified, particulate, hydrophobic polymers, the surface of which has been cationically modified by coating with cationic polymers, and the particle size of which is 10 nm to 100 μm,
(b) 0.1 to 40% by weight of at least one nonionic and/or anionic surfactant,
(c) 0-10% by weight of a cationic polymer,
(d) 0-20% by weight of a water-soluble salt of Mg, Ca, Zn or Al and/or of a cationic surfactant,
(e) 0 to 80% by weight of an inorganic builder, extender and/or scouring agent,
(f) 0 to 20% by weight of a complexing agent and/or organic cobuilder,
(g) 0 to 10% by weight of other customary ingredients, such as brighteners, waxes, oils, perfume, corrosion inhibitors, bleaches, bleach activators, bleach catalysts, dyes and
(h) water to 100%.

21. An afterrinse and impregnation formulation in liquid or gel form which comprises
(a) 0.05 to 30% by weight of cationically modified, particulate, hydrophobic polymers, the surface of which has been cationically modified by coating with cationic polymers, and the particle size of which is 10 nm to 100 μm,
(b) 0.1 to 30% by weight of at least one nonionic or anionic surfactant,
(c) 0 to 10% by weight of at least one acid, preferably a carboxylic acid,
(d) 0-10% by weight of a cationic polymer,
(e) 0-20% by weight of a water-soluble salt of Mg, Ca, Zn or Al and/or of a cationic surfactant,
(f) 0 to 10% by weight of other customary ingredients, such as thickeners, complexing agents, solvents, oils, waxes, hydrotropic agents, foam-suppressing agents, polycarboxylic acids, silicones, brighteners, perfume, dyes and
(g) 0 to 90% by weight of water.
